(19) United States
(12) Patent Application Publication
(10) Pub. No.: US 2024/0346340 A1
(43) Pub. Date: Oct. 17, 2024

(54) SYSTEMS AND METHODS FOR ANALYZING DATA STREAMS

(71) Applicant: Capital One Services, LLC, McLean, VA (US)

(72) Inventor: Hari Hara Sudhan GNANAPRAKASAM, Glen Allen, VA (US)

(73) Assignee: Capital One Services, LLC, McLean, VA (US)

(21) Appl. No.: 18/301,954

(22) Filed: Apr. 17, 2023

(51) Int. Cl. G06N 5/022

(52) U.S. Cl. CPC G06N 5/022

(57) ABSTRACT

Systems and methods for analyzing data streams. In some aspects, the system receives a data stream including events associated with a plurality of users assigned to a token. The system processes the data stream to extract a first substream including events associated with a first user and a second substream including events associated with a second user. The system generates a first profile for the first user and a second profile for the second user. The system processes the first profile to determine that the first profile is associated with a cluster of profiles. The system processes the first substream to determine that the first substream includes events associated with the cluster of profiles and is above a threshold related to the cluster of profiles to trigger a notification to a first user device associated with the first user.

### SUMMARY

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence often relies on large amounts of high-quality data. The process for obtaining this data and ensuring it is high-quality is often complex and time-consuming. Second, despite the mainstream popularity of artificial intelligence, practical implementations of artificial intelligence require specialized knowledge to design, program, and integrate artificial intelligence-based solutions, which limits the number of people and resources available to create these practical implementations. Finally, results based on artificial intelligence are notoriously difficult to review as the process by which the results are made may be unknown or obscured. This obscurity creates hurdles for identifying errors in the results, as well as improving the models providing the results. These technical problems present an inherent problem with attempting to use an artificial intelligence-based solution in generating personalized recommendations for users sharing a streaming service account or another suitable token or account shared among multiple users.

In some embodiments, to address one or more of the technical problems described above, methods and systems are described herein for novel uses and/or improvements to artificial intelligence applications. As one example, methods and systems are described herein for providing personalized recommendations to users based on individual activity without having separate service accounts. The system may receive a data stream including events associated with a plurality of users assigned to a token. The system may then process the data stream using a first machine learning model to extract a first substream including events associated with a first user and a second substream including events associated with a second user. The system may generate a first profile for the first user based on the first substream and a second profile for the second user based on the second substream. The system may process the first profile using a second machine learning model to determine that the first profile is associated with a first cluster of profiles. This allows the system to process the first substream using a third machine learning model to determine that the first substream includes events associated with the first cluster of profiles and is above a threshold to trigger a notification. This threshold may be the same or different across different clusters. Based on determining that the first substream includes events above the threshold, the system is able to generate the notification to a first user device associated with the first user.

Existing systems fail to distinguish different users' activities when those users share an account in a manner that is conducive to providing personalized recommendations, e.g., to a target device associated with a particular user. For example, existing systems fail to detect the source of data when there are multiple substreams present in a data stream such that they may be used to provide recommendations to user devices for particular users. However, the difficulty in adapting artificial intelligence models for this practical benefit faces several technical challenges, such as the inability for machine learning models to determine one or more substreams interleaved within a data stream that is associated with a token or which user device is associated with a particular substream, which leads to inaccurate results when generating predictions.

To overcome these technical deficiencies in adapting artificial intelligence models for this practical benefit, methods and systems disclosed herein use machine learning models to generate separate profiles for each user associated with a substream detected in a data stream and to classify each profile within one or more clusters to generate personalized recommendations for each user. For example, by using machine learning models to generate separate profiles for each user and to classify each profile within one or more clusters, the system is able to build a system to provide personalized recommendations to each user among multiple users that share an account. Accordingly, the methods and systems provide recommendations to users based on individual activity without having separate service accounts.

The system may receive a data stream. In particular, the system may receive a data stream including events associated with a plurality of users assigned to the same token. For example, the system may receive a data stream including user activity for multiple users under the same account, such as a streaming service account. By receiving the data stream, the system is able to start processing the data associated with the same token.

The system may process the data stream. In particular, the system may process the data stream using a first machine learning model to extract a first substream including events associated with a first user and conducted using the token and a second substream including events associated with a second user and conducted using the token. For example, the system may process the data stream from the service platform associated with the service account to extract user activity for a first user and a second user. By doing so, the system may differentiate the substreams within the data stream.

The system may generate a first profile. In particular, the system may generate a first profile for the first user based on the first substream and a second profile for the second user based on the second substream. For example, the system may generate a profile for the first user. This profile would include the user activities and history of the first user. The system may generate a separate profile for the second user. By doing so, the system is able to distinguish data from the separate substreams corresponding to the different users.

The system may process the first profile. In particular, the system may process the first profile using a second machine learning model to determine that the first profile is associated with a first cluster of profiles. For example, the system may process many service accounts. After processing the accounts, the system may use a machine learning model to classify the user activity into categories, such as genres. The system may then determine what each user prefers using the data collected from the profile. By doing so, the system is able to classify the profiles to predict personalized recommendations for each individual user.

The system may process the first substream. In particular, the system may process the first substream using a third machine learning model to determine that the first substream includes events associated with the first cluster of profiles and is above a threshold related to the first cluster of profiles to trigger a notification related to the first cluster of profiles. For example, the system may use a third machine learning model to determine whether the first user's favorite genre is romance when it is classified as such. The third machine learning model may determine the first user's profile indicates the first user's favorite genre is action. By doing so, the system ensures accuracy when providing recommendations.

The system may generate a notification. In particular, the system may, based on determining that the first substream includes events above the threshold, generate the notification to a first user device associated with the first user associated with the first cluster of profiles. For example, the system may generate a notification on the first user's device recommending a new activity related to the service account. By doing so, the system ensures the user is able to see the recommendation and respond to it.

In some embodiments, the system may determine the user device is within a threshold distance. The system may determine the user device is associated with events within the first substream. For example, the system may determine a location where a user uses the streaming service. The system may determine a user device near the location and verify the user device is associated with events within the first substream. By doing so, the system is able to determine a first user device to send the notification.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for determining one or more substreams interleaved within a data stream that is associated with a token, in accordance with one or more embodiments.

FIG. 2 shows an illustrative diagram for processing a data stream to determine a first substream that includes events associated with a first cluster of profiles to trigger a notification, in accordance with one or more embodiments.

FIG. 3 shows illustrative components for a system used to process one or more substreams using machine learning models, in accordance with one or more embodiments.

FIG. 4 shows an illustrative diagram for a system used to determine one or more substreams interleaved within a data stream in accordance with one or more embodiments.

FIG. 5 shows a flowchart of a method for determining one or more substreams interleaved within a data stream that is associated with a token, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

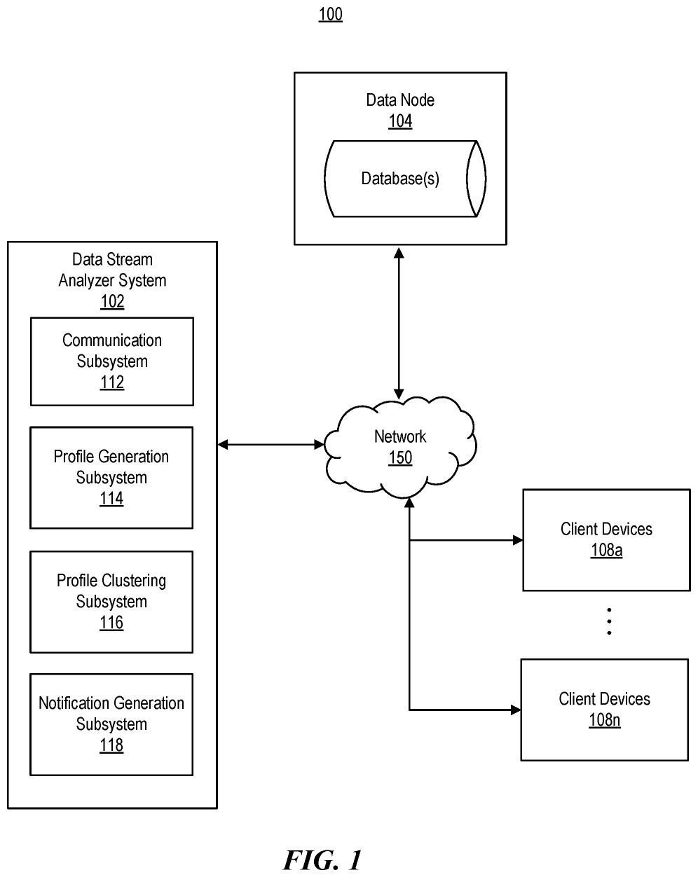

FIG. 1 shows an illustrative diagram for determining one or more substreams interleaved within a data stream that is associated with a token, in accordance with one or more embodiments. Environment 100 includes data stream analyzer system 102, data node 104, and client devices 108a-108n. Data stream analyzer system 102 may include software, hardware, or a combination of both and may reside on a physical server or a virtual server running on a physical computer system. In some embodiments, data stream analyzer system 102 may be configured on a user device (e.g., a laptop computer, a smartphone, a desktop computer, an electronic tablet, or another suitable user device). Furthermore, data stream analyzer system 102 may reside on a cloud-based system and/or interface with computer models either directly or indirectly, for example, through network 150. Data stream analyzer system 102 may include communication subsystem 112, profile generation subsystem 114, profile clustering subsystem 116, and/or notification generation subsystem 118.

Data node 104 may store various data, including one or more machine learning models, training data, user data profiles, input data, output data, performance data, and/or other suitable data. Data node 104 may include software, hardware, or a combination of the two. In some embodiments, data stream analyzer system 102 and data node 104 may reside on the same hardware and/or the same virtual server or computing device. Network 150 may be a local area network, a wide area network (e.g., the Internet), or a combination of the two.

Client devices 108a-108n may include software, hardware, or a combination of the two. For example, each client device may include software executed on the device or may include hardware, such as a physical device. Client devices may include user devices (e.g., a laptop computer, a smartphone, a desktop computer, an electronic tablet, or another suitable user device).

Data stream analyzer system 102 may receive a data stream from one or more client devices. Data stream analyzer system 102 may receive data using communication subsystem 112, which may include software components, hardware components, or a combination of both. For example, communication subsystem 112 may include a network card (e.g., a wireless network card and/or a wired network card) that is associated with software to drive the card and enables communication with network 150. In some embodiments, communication subsystem 112 may also receive data from and/or communicate with data node 104 or another computing device. Communication subsystem 112 may receive data, such as data streams from user devices. Communication subsystem 112 may communicate with profile generation subsystem 114, profile clustering subsystem 116, and notification generation subsystem 118.

Data stream analyzer system 102 may include profile generation subsystem 114. Communication subsystem 112 may pass at least a portion of the data or a pointer to the data in memory to profile generation subsystem 114. Profile generation subsystem 114 may include software components, hardware components, or a combination of both. For example, profile generation subsystem 114 may include software components or may include one or more hardware components (e.g., processors) that are able to execute operations for generating profiles based on substreams from the data stream from client devices 108a-108n. Profile generation subsystem 114 may access data, such as events from the data stream. Profile generation subsystem 114 may directly access data or nodes associated with client devices 108a-108n and may transmit data to these client devices. Profile generation subsystem 114 may, additionally or alternatively, receive data from and/or send data to communication subsystem 112, profile clustering subsystem 116, or notification generation subsystem 118.

Profile clustering subsystem 116 may execute tasks relating to clustering the generated profiles from profile generation subsystem 114. Profile clustering subsystem 116 may include software components, hardware components, or a combination of both. For example, profile clustering subsystem 116 may include software components or may include one or more hardware components (e.g., processors) that are able to execute operations for clustering on the generated profiles. For example, in some embodiments, profile clustering subsystem 116 may receive data output from a machine learning model. Profile clustering subsystem 116 may receive input data from client devices 108a-108n. Profile clustering subsystem 116 may, additionally or alternatively, receive data from and/or send data to communication subsystem 112, profile generation subsystem 114, or notification generation subsystem 118.

Notification generation subsystem 118 may execute tasks relating to generating notifications to client devices 108a-108n. Notification generation subsystem 118 may include software components, hardware components, or a combination of both. For example, notification generation subsystem 118 may include software components or may include one or more hardware components (e.g., processors) that are able to execute operations for generating notifications. For example, in some embodiments, notification generation subsystem 118 may receive data output from a machine learning model. Notification generation subsystem 118 may receive input data from client devices 108a-108n. Notification generation subsystem 118 may, additionally or alternatively, receive data from and/or send data to communication subsystem 112, profile generation subsystem 114, or profile clustering subsystem 116.

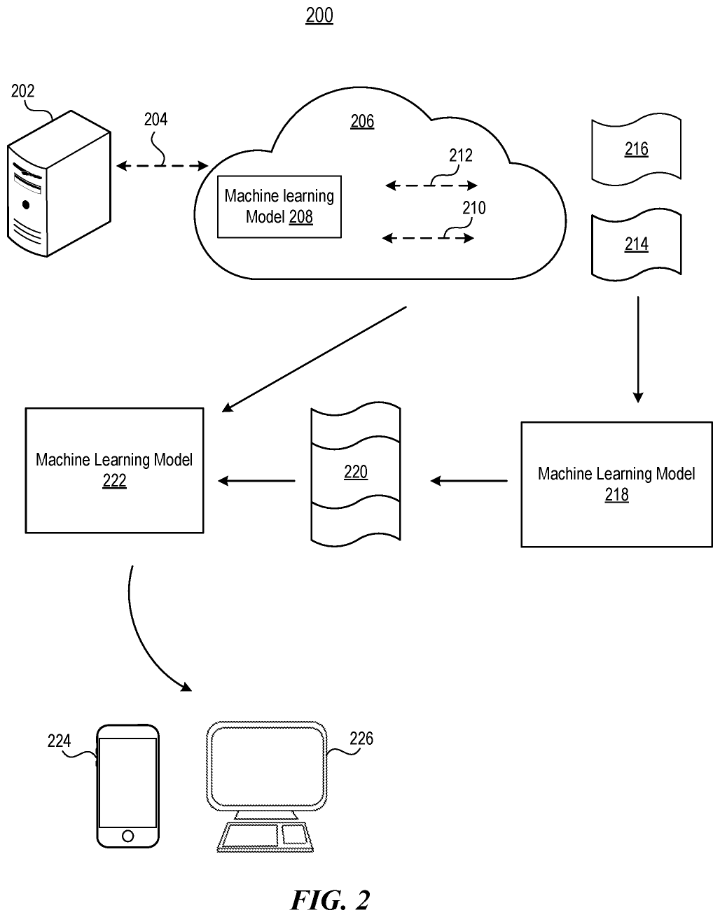

FIG. 2 shows an illustrative diagram for processing a data stream to determine a first substream that includes events associated with a first cluster of profiles to trigger a notification. FIG. 2 shows environment 200. Environment 200 includes device 202, data stream 204, cloud components 206, machine learning model 208, data substream 210, data substream 212, profile 214, profile 216, machine learning model 218, profile cluster 220, machine learning model 222, user device 224, and user device 226.

Data stream analyzer system 102 may receive a data stream (e.g., data stream 204) via communication subsystem 112. In particular, data stream analyzer system 102 may receive data stream 204 including events associated with at least a first user and second user assigned to a token. For example, the system may receive data stream 204 including the shows each user watches under the same streaming service account. By receiving the data stream (e.g., data stream 204), the system is able to start processing the data associated with the same token.

In some embodiments, data stream analyzer system 102 may validate the events associated with the first user. In particular, data stream analyzer system 102, when processing the data stream (e.g., data stream 204) using a first machine learning model (e.g., machine learning model 208) to extract a first substream (e.g., data substream 210), may include validating the events associated with the first user are conducted using the token. For example, data stream analyzer system 102 may receive multiple events from multiple users; therefore, data stream analyzer system 102 validates that all the shows the first user watches are from the same account.

In some embodiments, data stream analyzer system 102 may determine a time stamp of when the events occurred. In particular, data stream analyzer system 102, when processing the data stream (e.g., data stream 204) using a first machine learning model (e.g., machine learning model 208) to extract a first substream (e.g., data substream 210) including events associated with a first user and a second substream (e.g., data substream 212) including events associated with a second user, may include determining the first substream (e.g., data substream 210) that includes a time stamp when the events occurred. For example, data stream analyzer system 102 may receive a time stamp from the data substreams 210 and 212 to determine which event is associated with which user. For example, data stream analyzer system 102 may determine using machine learning model 208 that events that occur in the morning are associated with the first user and events that occur in the evening are associated with the second user. By doing so, the system may differentiate the users and the data substreams from one another.

In some embodiments, data stream analyzer system 102 may store event data associated with the token. In particular, data stream analyzer system 102, when processing the data stream using the first machine learning model (e.g., machine learning model 208) to extract the first substream (e.g., data substream 210) including the events associated with the first user, may transmit a request to a first database for the data stream (e.g., data stream 204). The first database stores event data from one or more event trackers. Data stream analyzer system 102 may receive the data stream (e.g., data stream 204) from the first database. Data stream analyzer system 102 may identify the events associated with the first user within the data stream (e.g., data stream 204). Data stream analyzer system 102 may generate the first substream (e.g., data substream 210) including the events associated with the first user. Data stream analyzer system 102 may transmit the first substream (e.g., data substream 210) including the events associated with the first user to a second database. The second database stores event data associated with the token. For example, data stream analyzer system 102 may receive data stream 204 from a database that stores what shows the users watch from the streaming service platform. From data stream 204, data stream analyzer system 102 may use machine learning model 208 to determine which shows are being watched by the first user and generate a substream that only includes shows that the first user is watching. Data stream analyzer system 102 may store the shows the first user watched to process the data using machine learning model 218. By doing so, data stream analyzer system 102 may recommend new shows for the user to watch.

In some embodiments, data stream analyzer system 102 may identify a flag for validating events. In particular, data stream analyzer system 102, when processing the data stream using the first machine learning model (e.g., machine learning model 208) to extract the first substream (e.g., data substream 210) including events associated with the first user, may include identifying a first flag for validating events associated with the first user. For example, data stream analyzer system 102 may validate that the shows the user watch are actually being watched by the user and not another user. Therefore, the data stream analyzer system 102 may validate the location from where the user is watching and flag the data as true or false when processing data stream 204. By doing so, data stream analyzer system 102 is able to validate that the first user is watching and not the second user, which allows the system to make accurate recommendations for each individual.

Data stream analyzer system 102 may process the data stream (e.g., data stream 204) using a first machine learning model (e.g., machine learning model 208) to extract a first substream (e.g., data substream 210) associated with the first user and a second substream (e.g., data substream 212) associated with the second user. In particular, data stream analyzer system 102 may process data stream 204 using machine learning model 208 to extract a data substream 210 including events associated with a first user and conducted using the token, and a substream 212 including events associated with a second user and conducted using the token. For example, data stream analyzer system 102 may process data stream 204, which originates from a streaming service platform to extract shows a first user watches and shows a second user watches. The first user and second user are associated with the same streaming service account. By doing so, the system may parse the data from data stream 204 to know which user is associated with which events within data stream 204.

Data stream analyzer system 102 may generate a first profile (e.g., profile 214) for the first user and a second profile (e.g., profile 216) for the second user via profile generation subsystem 114. In particular, data stream analyzer system 102 may generate a first profile (e.g., profile 214) for the first user based on the first substream (e.g., data substream 210) and a second profile (e.g., profile 216) for the second user based on the second substream (e.g., data substream 212). For example, data stream analyzer system 102 may generate profile 214 for the first user. Profile 214 would include the streaming activities and history of the first user. Data stream analyzer system 102 may generate profile 216 for the second user. By doing so, the system is able to collect data from the separate substreams (e.g., data substreams 210 and 212) corresponding to the different users.

Data stream analyzer system 102 may process the first profile (e.g., profile 214) using a second machine learning model (e.g., machine learning model 218) to determine that the first profile (e.g., profile 214) is associated with a first cluster of profiles (e.g., profile cluster 220) via profile clustering subsystem 116. In particular, data stream analyzer system 102 may process profile 214 using machine learning model 218 to determine that profile 214 is associated with profile cluster 220. For example, data stream analyzer system 102 may process many different streaming service accounts. After processing the accounts, the data stream analyzer system 102 may use a machine learning model (e.g., machine learning model 218) to classify the shows into clusters (e.g., genres such as romance, action, and comedy). Data stream analyzer system 102 may then process each user in an account to classify each user using the data collected from the user's profile. By doing so, the system is able to predict personalized recommendations for each individual user.

In some embodiments, data stream analyzer system 102 may use a machine learning model (e.g., machine learning model 218) to cluster profiles. In particular, data stream analyzer system 102, when processing the first profile (e.g., profile 214) using the second machine learning model (e.g., machine learning model 218) to determine that the first profile (e.g., profile 214) is associated with the first cluster of profiles (e.g., profile cluster 220), may process the events associated with the first user, using a classification function, to determine an event type that was most frequent. Data stream analyzer system 102 may associate the first profile (e.g., profile 214) with the first cluster of profiles (e.g., profile cluster 220) associated with the most frequent event type. For example, data stream analyzer system 102 may process profile 214 to determine that the first user watches mainly romance by processing the genre of each show the user watches. Data stream analyzer system 102 may then add profile 214 to profile cluster 220. Profile cluster 220 may include profiles that mainly watch romance shows.

Data stream analyzer system 102 may process the first substream (e.g., data substream 210) using a third machine learning model (e.g., machine learning model 222) to determine that the first substream (e.g., data substream 210) is above a threshold. In particular, data stream analyzer system 102 may process the first substream (e.g., data substream 210) using a third machine learning model (e.g., machine learning model 222) to determine that the first substream (e.g., data substream 210) includes events associated with the first cluster of profiles (e.g., profile cluster 220) and is above a threshold related to the first cluster of profiles (e.g., profile cluster 220) to trigger a notification related to the first cluster of profiles (e.g., profile cluster 220). For example, data stream analyzer system 102 may use machine learning model 222 to determine whether the users in the account were accurately clustered using a threshold. After that threshold is met, data stream analyzer system 102 may trigger a notification. For example, machine learning model 222 may set a threshold amount of watching five romance shows to trigger a notification of a recommendation of a new romance show to watch. However, machine learning model 222 may also determine the first user's profile indicates the first user's favorite genre is action after it determines the profile does not meet the threshold for the romance category. After that, data stream analyzer system 102 may generate a notification. By doing so, the system ensures accuracy when providing recommendations.

In some embodiments, data stream analyzer system 102 may determine the threshold. In particular, the threshold to trigger the notification is based on information for the first user extracted from the first substream with an event tracker. The threshold may include the total number of events conducted by the first user with the token and associated with a first event type. For example, data stream analyzer system 102 may determine the threshold to be that the user watches at least five romance shows to be included in profile cluster 220 by analyzing data substream 210. After the user watches at least five romance shows, the system is able to generate a notification of a new recommendation of what to watch.

In some embodiments, data stream analyzer system 102 may determine whether the events associated with the first profile (e.g., profile 214) are above the threshold. In particular, data stream analyzer system 102, when processing the first substream (e.g., data substream 210) using a third machine learning model (e.g., machine learning model 222) to determine that the first substream (e.g., data substream 210) includes events associated with the first cluster of profiles (e.g., profile cluster 220) and is above a threshold to trigger a notification, may include determining, for the first cluster of profiles (e.g., profile cluster 220), the threshold to trigger the notification. Data stream analyzer system 102 may process the first substream (e.g., data substream 210) to identify the events associated with the first profile (e.g., profile 214). Data stream analyzer system 102 may determine, for the first profile (e.g., profile 214), whether the events are above the threshold. For example, data stream analyzer system 102 may determine a threshold to trigger a notification. For example, data stream analyzer system 102 may determine the threshold to trigger a notification may include watching ten shows. Then, data stream analyzer system 102 may process data substream 210 to determine how many shows the user has watched. For example, data stream analyzer system 102 may determine the user watched nine romance shows. After that, data stream analyzer system 102 may generate a notification of a recommendation once the user starts watching their tenth romance show. By doing so, the system is able to control when to recommend a show to a user.

Data stream analyzer system 102 may generate a notification to a first user device associated with the first user via notification generation subsystem 118. In particular, data stream analyzer system 102, based on determining that the first substream (e.g., data substream 210) includes events above the threshold, may generate a notification to a first user device (e.g., user devices 224 and 226) associated with the first user associated with the first cluster of profiles (e.g., profile cluster 220). For example, data stream analyzer system 102 may generate a notification on user device 224 or user device 226 recommending a new show for them to watch on the streaming service. By doing so, the system ensures the user is able to see the recommendation and respond to it.

In some embodiments, data stream analyzer system 102 may determine a user device. In particular, data stream analyzer system 102, when generating the notification to the first user device (e.g., user device 224) associated with the first user, may determine a user device (e.g., user device 224) from a plurality of user devices associated with the token. For example, data stream analyzer system 102 may determine user device 224 is associated with the first user. In some embodiments, data stream analyzer system 102 may determine the first user device (e.g., user device 224) may include determining the user device (e.g., user device 224) within a threshold distance to events associated with the first user. In some embodiments, data stream analyzer system 102 may determine the user device is within the threshold distance and determine whether the user device is associated with events within the first substream. For example, data stream analyzer system 102 may determine user device 224 is the first user device by checking the location where the first user usually watches. For example, the first user may watch shows at school, while the second user may only watch shows at home. Data stream analyzer system 102 may determine the user device 224 is the first user device since it stores the shows associated with the first user and is only active with the streaming service when at the first user's school location. By doing so, the system is able to push notifications for profiles associated with the same account to each individual user without users having separate accounts.

In some embodiments, data stream analyzer system 102 may receive a feedback response from a user. In particular, data stream analyzer system 102 may receive a negative feedback response from the first user with respect to the notification. Data stream analyzer system 102, subsequent to receiving the negative feedback response, may detect in the first substream (e.g., data substream 210) new events associated with the first user. Data stream analyzer system 102 may update the first profile for the first user (e.g., profile 214) based on the new events. Data stream analyzer system 102 may process the updated first profile using the second machine learning model (e.g., machine learning model 218) to determine that the updated first profile is associated with a new cluster of profiles. For example, data stream analyzer system 102 may receive from the first user a response. The response may include that the first user rejected the recommendation made by the system. In response, data stream analyzer system 102 may reevaluate the shows the first user watches. For example, data stream analyzer system 102 may determine the first user watched new shows. Each new show may be categorized as action. Therefore, data stream analyzer system 102 may classify profile 214 as action now and generate a new recommendation. By doing so, the system is able to adapt to the user's change in event data.

In some embodiments, data stream analyzer system 102 may receive data stream 204 including user purchases that are associated with at least a first user and second user using the same token (e.g., a joint account) via communication subsystem 112. Data stream analyzer system 102 may process data stream 204 using machine learning model 208 to extract data substream 210, including purchases associated with the first user, and data substream 212, including purchases associated with the second user. In some embodiments, data stream analyzer system 102 may validate that the purchases associated with the first user were made using the joint credit card account. In some embodiments, data stream analyzer system 102 may receive a time stamp of when purchases were made. This allows the system to analyze which purchases were made by each user by analyzing their spending habits. For example, the first user may only make purchases in the morning, while the second user may only make purchases in the evening. In some embodiments, data stream analyzer system 102 may validate that the user pays their bill before pushing a credit card reward by identifying a flag within data substream 210 that indicates whether each purchase was paid or not.

Data stream analyzer system 102 may generate profile 214 based on data substream 210 and profile 216 based on data substream 212 via profile generation subsystem 114. For example, the system may generate a first profile that stores the purchases made by the first user. Data stream analyzer system 102 may process profile 214 using machine learning model 218 to determine that profile 214 is associated with a first cluster of profiles (e.g., profile cluster 220) via profile clustering subsystem 116. For example, the data stream analyzer system 102 may analyze the purchases made by the first user using a machine learning model (e.g., machine learning model 218) to cluster users based on spending categories (e.g., travel, dining, and entertainment) to determine which cluster the first user should belong to. For example, the system may classify the first profile (e.g., profile 214) into the travel cluster (e.g., profile cluster 220). In some embodiments, data stream analyzer system 102 may classify the first profile (e.g., profile 214) by processing the first user's purchases to determine which spending category was most frequent. For example, the system may determine the first user is a frequent flier and classify the first profile (e.g., profile 214) into a travel cluster (e.g., profile cluster 220).

Data stream analyzer system 102 may process the data substream 210 using machine learning model 222 to determine that data substream 210 includes purchases associated with profile cluster 220 (e.g., travel) and is above a threshold to the first cluster of profiles to trigger a notification related to profile cluster 220 via notification generation subsystem 118. Data stream analyzer system 102 may determine the threshold to trigger the notification based on the purchases made by user. For example, the system may determine the threshold may include a total number of purchases. For example, the system may trigger the notification after the threshold is met. For example, the system may send a credit card reward after the first user purchases ten travel purchases.

Data stream analyzer system 102, based on determining that data substream 210 includes purchases associated with profile cluster 220 (e.g., travel) are above the threshold, may generate the notification (e.g., a credit card reward) to a first user device associated with the first user (e.g., user devices 224). In some embodiments, data stream analyzer system 102 may determine which user device belongs to the first user when generating a notification for the first user. In some embodiments, data stream analyzer system 102 may determine a location associated with each user. For example, the system may determine the first user makes purchases in a first location, while the second user makes purchases in a second location. By analyzing the location of the purchase, the system is able to determine which user device corresponds to which profile. In some embodiments, data stream analyzer system 102 may notice both the first user and second user are making purchases in the same location. The system may determine the first user device by validating that the first user device is within a threshold distance and that the first user device (e.g., user devices 224 or 226) is associated with the purchases made by the first user. By doing so, the system is able to determine which user device to deliver the credit card reward.

In some embodiments, data stream analyzer system 102 may receive feedback from the user on the notification via communication subsystem 112. For example, data stream analyzer system 102 may receive negative feedback (e.g., the user rejects the credit card reward). In response to the feedback, data stream analyzer system 102 may detect new purchases from data substream 210 associated with the first user. Data stream analyzer system 102 may update profile 214 based on the new purchases. Data stream analyzer system 102 may process the updated profile 214 to determine whether updated profile 214 may be classified into a new cluster of profiles. For example, after receiving a travel credit card reward, the user may reject the reward. The system, in response, may detect new purchases that can be categorized as dining. Therefore, the system may cluster the first profile (e.g., profile 214) into the dining cluster and generate a new notification (e.g., a new credit card reward) that is associated with the dining cluster. By doing so, the system is able to update and generate new rewards as user's purchases change throughout time.

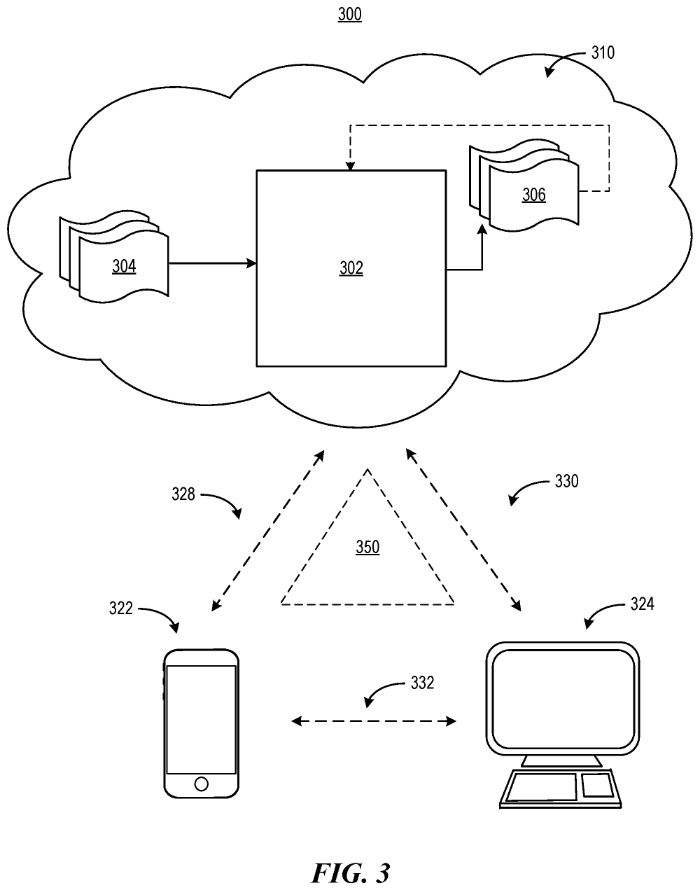

FIG. 3 shows illustrative components for a system used to process one or more substreams using machine learning models, in accordance with one or more embodiments. For example, FIG. 3 may show illustrative components for providing personalized recommendations directly to user devices based on individual activity while sharing the same token. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include data stream analyzer system 102, communication subsystem 112, profile generation subsystem 114, profile clustering subsystem 116, notification generation subsystem 118, data node 104, and client devices 108a-108n, and may be connected to network 150. Cloud components 310 may access data stream 204, and user devices 224 and 226.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., personal recommendations for the user).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., classifying user profiles into clusters based on events data).

In some embodiments, the model (e.g., model 302) may automatically perform actions based on outputs 306. In some embodiments, the model (e.g., model 302) may not perform any actions. The output of the model (e.g., model 302) may be used to classify user profiles into clusters.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

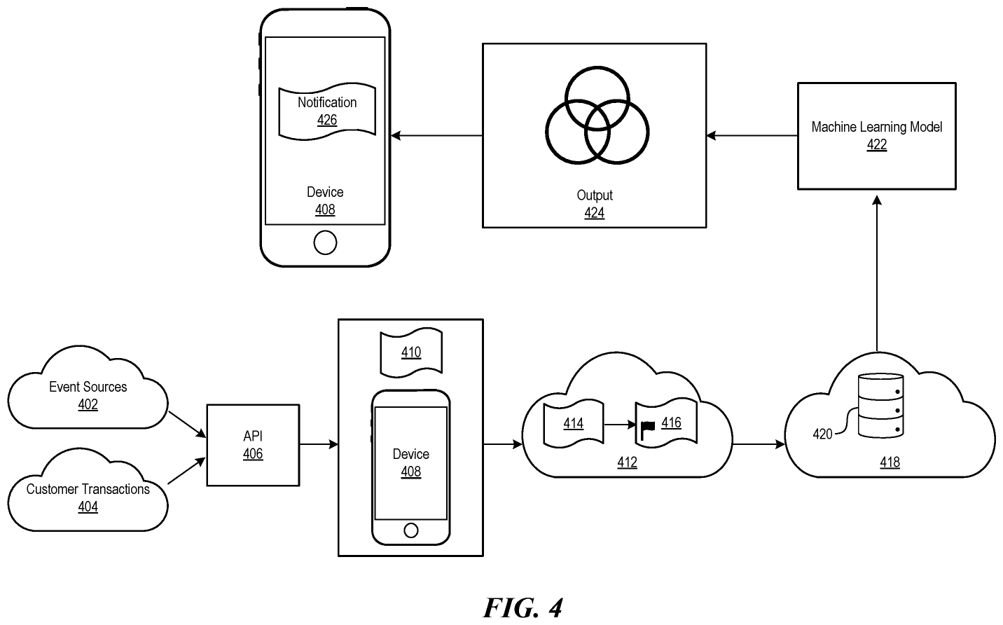

FIG. 4 shows an illustrative diagram for a system used to determine one or more substreams interleaved within a data stream in accordance with one or more embodiments. FIG. 4 shows environment 400. Environment 400 includes cloud 402, cloud 404, API 406, user device 408, data 410, cloud 412, data 414, flagged data 416, cloud 418, database 420, machine learning model 422, output 424, notification 426, and user device 428.

Cloud 402 may include a first database. The first database may store events data associated with the token. For example, an API (e.g., API 406) collects events data from event tracking websites in the form of JSON, XML, and clickStreams data (e.g., data 410). This keeps the database updated with all types of events. An event may include a wide range of categories such as music concerts, theater shows, sports, travel, and/or hospitality experiences. These events are transported via API endpoints (e.g., API 406) and the data is stored in the database.

Cloud 404 may include a second database. The second database may store customer transaction data. The system may receive customer transaction data from user devices (e.g., user device 408). The system may receive customer transaction data on a daily basis through batch and streaming services. The system then stores the data in cloud 404.

Cloud 412 may include a third database. The third database may store payment information associated with the users. Cloud 412 may process the data (e.g., data 410) from cloud 402 and cloud 404. For example, an ETL process is performed on existing customer information and payment information. Cloud 412 validates payments were made on time by the user. For example, cloud 412 processes data 414 into flagged data 416 by flagging whether each payment was made on time or not. The data is then stored in cloud 418 via staging tables in database 420. Staging tables may refer to a temporary table that holds all of the data that will be used to make changes and updates. Sanity checks are performed on the data in staging tables for data quality. If the checks are successful, the data is finally loaded into target tables within database 420.

Machine learning model 422 receives data from database 420 on customer spending habits. Machine learning model 422 may identify customer spending categories such as travel, entertainment, retail, online gaming, theater, or arts. Machine learning model 422 may classify customers into clusters. For example, machine learning model 422 may use k-means clustering algorithm to cluster the customers into customer spending categories (e.g., output 424). Machine learning model 422 may update the cluster the customer is classified into. Machine learning model 422 may analyze customer spending habits to identify patterns. For example, a user may spend the majority of their money on kid activities such as traveling to theme parks and buying children's toys. Machine learning model 422 may store output 424 in a transactional database. Based on output 424, the system may generate notification 426 to user device 428. Machine learning model 422 may utilize data feedback from past notifications to validate if the user has utilized previous notifications.

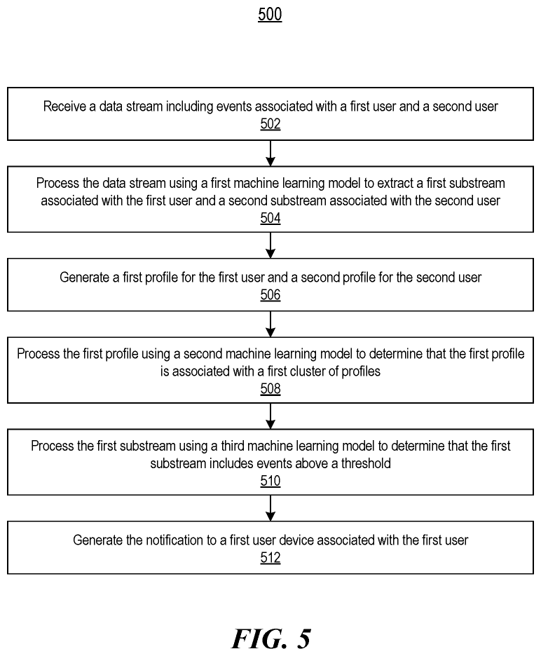

FIG. 5 shows a flowchart of the steps involved in determining one or more substreams interleaved within a data stream that is associated with a token, in accordance with one or more embodiments. For example, the system may use process 500 (e.g., as implemented on one or more system components described above) in order to provide personalized recommendations directly to user devices based on individual activity while sharing the same token.

At step 502, process 500 (e.g., using one or more components described above) may receive a data stream including events associated with a first user and a second user. For example, the system may receive a data stream including events associated with at least a first user and second user assigned to a token. For example, communication subsystem 112, which may reside on cloud components 310, may receive data stream 204 which may include events such as shows the first user watches and shows a second user watches under the same streaming service account. By doing so, the system may process the data stream to extract substreams and events associated with each user.

In some embodiments, data stream analyzer system 102 may validate the events associated with the first user. In particular, data stream analyzer system 102 when processing the data stream (e.g., data stream 204) using a first machine learning model (e.g., machine learning model 208) to extract a first substream (e.g., data substream 210) may include validating the events associated with the first user are conducted using the token. For example, data stream analyzer system 102 may receive multiple events from multiple users, therefore data stream analyzer system 102 validates all the shows the first user watches are from the same account.

In some embodiments, the system may determine a time stamp of when the events occurred. In particular, the system when processing the data stream using a first machine learning model to extract a first substream including events associated with a first user and a second substream including events associated with a second user may determine the first substream includes a time stamp when the events occurred. For example, communication subsystem 112, which may reside on cloud components 310, may receive a time stamp from the data substreams 210 and 212 to determine which event is associated with which user. For example, the system may determine using machine learning model 208 that events that occur in the morning are associated with the first user and events that occur in the evening are associated with the second user. By doing so, the system may differentiate the users and the data substreams from one another.

In some embodiments, the system may store event data associated with the token. In particular, the system when processing the data stream using the first machine learning model to extract the first substream including the events associated with the first user may transmit a request to a first database for the data stream. The first database stores event data from one or more event trackers. The system may receive the data stream from the first database. The system may identify the events associated with the first user within the data stream. The system may generate the first substream including the events associated with the first user. The system may transmit the first substream including the events associated with the first user to a second database. The second database stores event data associated with the token. For example, communication subsystem 112 may receive data stream 204 from a database (e.g., a database 420) that stores what shows the users watch from the streaming service platform. From data stream 204, the system may use a machine learning model (e.g., machine learning model 208, model 302, or machine learning model 422) to determine which shows are being watched by the first user and generate a substream that only includes shows that first user is watching. The system may store the shows the first user watches to process the data using machine learning model 218. By doing so, the system may recommend new shows for the user to watch by parsing the data to know which user is using the account.

In some embodiments, the system may identify a flag for validating events. In particular, the system when processing the data stream using the first machine learning model to extract the first substream including events associated with the first user may include identifying a first flag for validating events associated with the first user. For example, notification generation subsystem 118, which may reside on cloud components 310, may identify a first flag when validating events before generating the notification. For example, notification generation subsystem 118 may process the data on cloud 412 and identify flagged data 416. By doing so, the system is able to validate that the first user is watching and not the second user, which allows the system to make accurate recommendations for each individual.

At step 504, process 500 (e.g., using one or more components described above) may process the data stream using a first machine learning model to extract a first substream associated with the first user and a second substream. For example, the system may process the data stream using a first machine learning model to extract a first substream including events associated with the first user and conducted using the token and a second substream including events associated with the second user and conducted using the token. For example, communication subsystem 112 may process data stream 204 using a machine learning model (e.g., machine learning model 208, model 302, or machine learning model 422) to extract data substream 210. By doing so, the system may parse the data coming from the data stream to determine which user is associated with the events data.

At step 506, process 500 (e.g., using one or more components described above) may generate a first profile for the first user and a second profile for the second user. For example, the system may generate a first profile for the first user based on the first substream and a second profile for the second user based on the second substream. For example, profile generation subsystem 114 may generate a first profile (e.g., profile 214) based on data substream 210 and a second profile (e.g., profile 216) based on data substream 212. By doing so, the system may separate the events data associated with each substream to further process the data and detect any patterns.

At step 508, process 500 (e.g., using one or more components described above) may process the first profile using a second machine learning model to determine that the first profile is associated with a first cluster of profiles. For example, the system may process the first profile using a second machine learning model to determine that the first profile is associated with a first cluster of profiles. For example, profile clustering subsystem 116, which may reside on cloud components 310, may process the first profile (e.g., profile 214) using a machine learning model (e.g., machine learning model 218, model 302, or machine learning model 422) to determine that profile 214 is associated with a first cluster or profile (e.g., profile cluster 220). By doing so, the system is able to generate and predict more shows the user would enjoy based on a cluster of shows that similar users enjoyed.

In some embodiments, the system may use a machine learning model to cluster profiles. In particular, the system when processing the first profile using the second machine learning model to determine that the first profile is associated with the first cluster of profiles may process the events associated with the first user, using a classification function, to determine an event type that was most frequent. The system may associate the first profile with the first cluster of profiles associated with the most frequent event type. For example, profile clustering subsystem 116 may process profile 214 to determine that the first user watches mainly romance by processing the genre of each show the user watches. Profile clustering subsystem 116 may then add profile 214 to profile cluster 220. By doing so, the system is able to generate recommendations based on other users' past watch history who enjoy the same shows as the first user.

At step 510, process 500 (e.g., using one or more components described above) may process the first substream using a third machine learning model to determine that the first substream includes events above a threshold. For example, the system may process the first substream using a third machine learning model to determine that the first substream includes events associated with the first cluster of profiles and is above a threshold related to the first cluster of profiles to trigger a notification related to the first cluster of profiles. For example, profile clustering subsystem 116 may process data substream 210 using a machine learning model (e.g., machine learning model 222, model 302, or machine learning model 422) to determine that data substream 210 includes events (e.g., events from cloud 402) with cluster 220 and is above a threshold related to cluster 220 to trigger notification 426 on user device 428. By doing so, the system may trigger a threshold to determine the user should receive a recommendation or reward for the amount of shows they have watched.

In some embodiments, the system may determine the threshold. In particular, the threshold to trigger the notification is based on information for the first user extracted from the first substream with an event tracker. The threshold may include a total number of events conducted by the first user with the token and associated with a first event type. For example, notification generation subsystem 118 may determine the threshold based on analyzing data substream 210 from cloud 402. The threshold may include a total number of events conducted by the first user with the token and associated with a first event type. For example, after the user watches at least five romance shows, the system is able to generate a notification of a new recommendation of what to watch. By doing so, the system may trigger a notification for the user.

In some embodiments, the system may determine whether the events associated with the first profile is above the threshold. In particular, the system when processing the first substream using a third machine learning model to determine that the first substream includes events associated with the first cluster of profiles and is above a threshold to trigger a notification may include determining, for the first cluster of profiles, the threshold to trigger the notification. The system may process the first substream to identify the events associated with the first profile. The system may determine, for the first profile, whether the events are above the threshold. For example, may determine a threshold to trigger a notification. For example, notification generation subsystem 118 may determine the threshold to trigger notification 426 may include watching ten shows. Then, the system may process data substream 210 to determine how many shows the user has watched. For example, the system may determine the user watched nine romance shows. After that, notification generation subsystem 118 may generate notification 426 to the user device (e.g., user device 224, 226 or 428) for a recommendation once the user starts watching their tenth romance show. By doing so, the system is able to control when to recommend a show to a user.

At step 512, process 500 (e.g., using one or more components described above) may generate the notification to a first user device associated with the first user. The system based on determining that the first substream includes events above the threshold, may generate notification to a first user device associated with the first user. For example, notification generation subsystem 118 may generate notification 426 to the user device (e.g., user device 224, 226 or 428) by determining that data substream 210 includes events associated with the first user. By doing so, the system may determine which user device is associated with each user.

In some embodiments, the system may determine a user device. The system when generating the notification to the first user device associated with the first user may determine a user device from a plurality of user devices associated with the token. For example, notification generation subsystem 118 may determine user device 224 is associated with the first user from a plurality of user devices.

In some embodiments, the system may determine the first user device may include determining the user device within a threshold distance to events associated with the first user. For example, notification generation subsystem 118 may receive from communication subsystem 112 a location where the user device is when events (e.g., events from cloud 402) take place. The system may determine a threshold distance where the user device may be located. By doing so, the system is able to determine which device to send the notification to.

In some embodiments, the system may determine the user device is within the threshold distance and determine whether the user device is associated with events within the first substream. The system may determine user device 224 is the first user device by checking the location where the first user usually watches. For example, the first user may watch shows at school while the second user may only watch shows at home. The system may determine the user device 224 is the first user device since it stores the shows associated with the first user and is only active with the streaming service when at the first user's school location. By doing so, the system is able to push notifications for profiles associated with the same account to each individual user without users having separate accounts.

In some embodiments, the system may receive a feedback response from a user. The system may receive a negative feedback response from the first user with respect to the notification. Subsequent to receiving the negative feedback response, the system may detect, in the first substream, new events associated with the first user. The system may update the first profile for the first user based on the new events. The system may process the updated first profile using the second machine learning model to determine that the updated first profile is associated with a new cluster of profiles. For example, communication subsystem 112 may receive from the first user device (e.g., user device 224, 226, or 428) a response. The response may include that the first user rejected the recommendation made by the system. In response to that, profile generation subsystem 114 may reevaluate the shows the first user watches. For example, profile generation subsystem 114 may determine the first user watched new shows. Each new show may be categorized as action. Therefore, the system may classify profile 214 as action now and generate a new recommendation (e.g., notification 426). By doing so, the system is able to adapt to the user's change in events data.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for determining one or more substreams interleaved within a data stream that is associated with a token, the method comprising: receiving a data stream including events associated with at least a first user and second user assigned to a token; processing the data stream using a first machine learning model to extract a first substream including events associated with the first user and conducted using the token and a second substream including events associated with the second user and conducted using the token; generating a first profile for the first user based on the first substream and a second profile for the second user based on the second substream; processing the first profile using a second machine learning model to determine that the first profile is associated with a first cluster of profiles; processing the first substream using a third machine learning model to determine that the first substream includes events associated with the first cluster of profiles and is above a threshold related to the first cluster of profiles to trigger a notification related to the first cluster of profiles; and based on determining that the first substream includes events above the threshold, generating the notification to a first user device associated with the first user.

2. A method for determining one or more substreams interleaved within a data stream that is associated with a token, the method comprising: processing, using a first machine learning model, a data stream including events associated with a plurality of users assigned to a token to extract a first substream including events associated with a first user; generating a first profile for the first user based on the first substream; processing the first profile using a second machine learning model to determine that the first profile is associated with a first cluster of profiles; processing the first substream using a third machine learning model to determine that the first substream includes events associated with the first cluster of profiles and is above a threshold to trigger a notification; and generating the notification to a first user device associated with the first user.

3. A method, the method comprising: processing a data stream including events associated with a plurality of users assigned to a token to extract a first substream including events associated with a first user; generating a first profile for the first user based on the first substream; processing the first profile to determine that the first profile is associated with a first cluster of profiles; processing the first substream to determine that the first substream includes events associated with the first cluster of profiles and is above a threshold to trigger a notification; and generating the notification to a first user device associated with the first user.

4. The method of any one of the preceding embodiments, wherein processing the data stream using a first machine learning model to extract a first substream comprises validating the events associated with the first user are conducted using the token.

5. The method of any one of the preceding embodiments, further comprising: receiving a negative feedback response from the first user with respect to the notification; subsequent to receiving the negative feedback response, detecting, in the first substream, new events associated with the first user; updating the first profile for the first user based on the new events to generate an updated first profile; and processing the updated first profile using the second machine learning model to determine that the updated first profile is associated with a new cluster of profiles.

6. The method of any one of the preceding embodiments, wherein processing the data stream using a first machine learning model to extract a first substream including events associated with a first user and a second substream including events associated with a second user comprises determining the first substream comprises a time stamp when the events occurred.

7. The method of any one of the preceding embodiments, wherein the threshold to trigger the notification is based on information for the first user extracted from the first substream with an event tracker.

8. The method of any one of the preceding embodiments, wherein the threshold comprises a total number of events conducted by the first user with the token and associated with a first event type.

9. The method of any one of the preceding embodiments, wherein generating the notification to the first user device associated with the first user comprises determining a user device from a plurality of user devices associated with the token.

10. The method of any one of the preceding embodiments, wherein determining the first user device comprises determining the user device within a threshold distance to events associated with the first user.

11. The method of any one of the preceding embodiments, wherein determining the user device within a threshold distance to events associated with the first user further comprises: determining the user device is within the threshold distance; and determining the user device is associated with events within the first substream.

12. The method of any one of the preceding embodiments, wherein processing the data stream using the first machine learning model to extract the first substream including the events associated with the first user comprises: transmitting a request to a first database for the data stream, wherein the first database includes event data from one or more event trackers; receiving the data stream from the first database; identifying the events associated with the first user within the data stream; generating the first substream including the events associated with the first user; and transmitting the first substream including the events associated with the first user to a second database, wherein the second database includes event data associated with the token.

13. The method of any one of the preceding embodiments, wherein processing the first profile using the second machine learning model to determine that the first profile is associated with the first cluster of profiles comprises: processing the events associated with the first user, using a classification function, to determine an event type that was most frequent; and associating the first profile with the first cluster of profiles associated with the event type that was most frequent.

14. The method of any one of the preceding embodiments, wherein processing the first substream using a third machine learning model to determine that the first substream includes events associated with the first cluster of profiles and is above a threshold to trigger a notification further comprises: determining, for the first cluster of profiles, the threshold to trigger the notification; processing the first substream to identify the events associated with the first profile; and determining, for the first profile, whether the events is above the threshold.

15. The method of any one of the preceding embodiments, wherein processing the data stream using the first machine learning model to extract the first substream including events associated with the first user comprises identifying a first flag for validating events associated with the first user.

16. A tangible, non-transitory, machine-readable medium storing instructions that, when executed by a data processing apparatus, cause the data processing apparatus to perform operations comprising those of any of embodiments 1-15.

17. A system comprising one or more processors; and memory storing instructions that, when executed by the processors, cause the processors to effectuate operations comprising those of any of embodiments 1-15.

18. A system comprising means for performing any of embodiments 1-15.

What is claimed is:

1. A system for determining one or more substreams interleaved within a data stream that is associated with a token, comprising:
one or more processors; and
a non-transitory computer-readable medium storing instructions that when executed by the one or more processors cause operations comprising:
receiving a data stream including events associated with at least a first user and second user assigned to a token;
processing the data stream using a first machine learning model to extract a first substream including events associated with the first user and conducted using the token and a second substream including events associated with the second user and conducted using the token;
generating a first profile for the first user based on the first substream and a second profile for the second user based on the second substream;
processing the first profile using a second machine learning model to determine that the first profile is associated with a first cluster of profiles;
processing the first substream using a third machine learning model to determine that the first substream includes events associated with the first cluster of profiles and is above a threshold related to the first cluster of profiles to trigger a notification related to the first cluster of profiles; and
based on determining that the first substream includes events above the threshold, generating the notification to a first user device associated with the first user.

2. A method for determining one or more substreams interleaved within a data stream that is associated with a token, comprising:
processing, using a first machine learning model, a data stream including events associated with a plurality of users assigned to a token to extract a first sub stream including events associated with a first user;
generating a first profile for the first user based on the first substream;
processing the first profile using a second machine learning model to determine that the first profile is associated with a first cluster of profiles;
processing the first substream using a third machine learning model to determine that the first substream includes events associated with the first cluster of profiles and is above a threshold to trigger a notification; and
generating the notification to a first user device associated with the first user.

3. The method of claim 2, wherein processing the data stream using a first machine learning model to extract a first substream comprises validating the events associated with the first user are conducted using the token.

4. The method of claim 2, further comprising:
receiving a negative feedback response from the first user with respect to the notification;
subsequent to receiving the negative feedback response, detecting, in the first substream, new events associated with the first user;
updating the first profile for the first user based on the new events to generate an updated first profile; and
processing the updated first profile using the second machine learning model to determine that the updated first profile is associated with a new cluster of profiles.

5. The method of claim 2, wherein processing the data stream using a first machine learning model to extract a first substream including events associated with a first user and a second substream including events associated with a second user comprises determining the first substream comprises a time stamp when the events occurred.

6. The method of claim 2, wherein the threshold to trigger the notification is based on information for the first user extracted from the first substream with an event tracker.

7. The method of claim 6, wherein the threshold comprises a total number of events conducted by the first user with the token and associated with a first event type.

8. The method of claim 2, wherein generating the notification to the first user device associated with the first user comprises determining a user device from a plurality of user devices associated with the token.

9. The method of claim 8, wherein determining the first user device comprises determining the user device within a threshold distance to events associated with the first user.

10. The method of claim 9, wherein determining the user device within a threshold distance to events associated with the first user, further comprises:
determining the user device is within the threshold distance; and
determining the user device is associated with events within the first substream.

11. The method of claim 2, wherein processing the data stream using the first machine learning model to extract the first substream including the events associated with the first user comprises:
transmitting a request to a first database for the data stream, wherein the first database includes event data from one or more event trackers;
receiving the data stream from the first database;
identifying the events associated with the first user within the data stream;
generating the first substream including the events associated with the first user; and
transmitting the first substream including the events associated with the first user to a second database, wherein the second database includes event data associated with the token.

12. The method of claim 2, wherein processing the first profile using the second machine learning model to determine that the first profile is associated with the first cluster of profiles comprises:
processing the events associated with the first user, using a classification function, to determine an event type that was most frequent; and
associating the first profile with the first cluster of profiles associated with the event type that was most frequent.

13. The method of claim 2, wherein processing the first substream using a third machine learning model to determine that the first substream includes events associated with the first cluster of profiles and is above a threshold to trigger a notification further comprises:
determining, for the first cluster of profiles, the threshold to trigger the notification;
processing the first substream to identify the events associated with the first profile; and
determining, for the first profile, whether the events are above the threshold.

14. The method of claim 2, wherein processing the data stream using the first machine learning model to extract the first substream including events associated with the first user comprises identifying a first flag for validating events associated with the first user.

15. A non-transitory, computer-readable storage medium storing instructions that, when executed by one or more processors, cause operations comprising:
processing a data stream including events associated with a plurality of users assigned to a token to extract a first substream including events associated with a first user;
generating a first profile for the first user based on the first substream;
processing the first profile to determine that the first profile is associated with a first cluster of profiles;
processing the first substream to determine that the first substream includes events associated with the first cluster of profiles and is above a threshold to trigger a notification; and
generating the notification to a first user device associated with the first user.

16. The non-transitory, computer-readable storage medium of claim 15, wherein the instructions, when executed by the one or more processors, cause further operations comprising:
receiving a negative feedback response from the first user with respect to the notification;
subsequent to receiving the negative feedback response, detecting, in the first substream, new events associated with the first user;
updating the first profile for the first user based on the new events to generate an updated first profile; and
processing the updated first profile to determine that the updated first profile is associated with a new cluster of profiles.

17. The non-transitory, computer-readable storage medium of claim 15, wherein determining the first user device further comprises:
determining a user device is within a threshold distance; and
determining the user device is associated with events within the first substream.

18. The non-transitory, computer-readable storage medium of claim 15, wherein processing the data stream to extract the first substream including the events associated with the first user comprises identifying a first flag for validating events associated with the first user.

19. The non-transitory, computer-readable storage medium of claim 15, wherein processing the data stream to extract the first substream including the events associated with the first user comprises:
transmitting a request to a first database for the data stream, wherein the first database includes event data from one or more event trackers;
receiving the data stream from the first database;
identifying the events associated with the first user within the data stream;
generating the first substream including the events associated with the first user; and
transmitting the first substream including the events associated with the first user to a second database, wherein the second database includes event data associated with the token.

20. The non-transitory, computer-readable storage medium of claim 15, wherein processing the first profile to determine that the first profile is associated with the first cluster of profiles comprises:
processing the events associated with the first user, using a classification function, to determine an event type that was most frequent; and
associating the first profile with the first cluster of profiles associated with the event type that was most frequent.
